(19) United States
(12) Patent Application Publication
(10) Pub. No.: US 2019/0248325 A1
(43) Pub. Date: Aug. 15, 2019

(54) SYSTEM AND METHOD FOR SECURING A VEHICLE

(71) Applicant: LSP Innovative Automotive Systems GmbH, Unterföhring (DE)

(72) Inventors: Alexander SCHMIDT, München (DE); Andreas ZELLER, Aschheim (DE); Thomas LEIBER, München (DE)

(21) Appl. No.: 16/319,312

(22) PCT Filed: Jul. 19, 2017
(86) PCT No.: PCT/EP2017/068272

§ 371 Date: Jan. 18, 2019

(30) Foreign Application Priority Data
Jul. 20, 2016 (DE) 10 2016 113 333.7

(51) Int. Cl. B60R 25/102; B60R 25/10; G07C 5/00; B60R 25/33

(52) U.S. Cl. CPC B60R 25/102; B60R 25/1003; G07C 5/008; B60R 25/33; B60Y 2200/13; B60R 2025/1016; B60Y 2200/12; B60R 2325/205; B60R 25/1004

(57) ABSTRACT

A system for securing of vehicles includes at least one server; at least one vehicle having a vehicle processing device and a vehicle communication device designed to communicate with the server via at least one mobile radio network, wherein the vehicle processing device is designed to transmit data to the server; and at least one mobile terminal device, in particular a smartphone. The server has at least one allocation table which assigns at least one terminal device to the at least one vehicle. The server is designed to: (a) determine, by using the transmitted data, whether the vehicle is being moved without authorization; (b) determine, in the event of unauthorized movement of the vehicle, the associated terminal device using the allocation table; and/or (c) send a warning message to the associated terminal device in the event of unauthorized movement.

### CROSS-REFERENCE TO RELATED APPLICATIONS

This application is a Section 371 of International Application No. PCT/EP2017/068272, filed Jul. 19, 2017, which was published in the German language on Jan. 25, 2018 under International Publication No. WO 2018/015455 A1, which claims priority under 35 U.S.C. § 119(b) to German Patent Application No. 10 2016 113 333.7, filed Jul. 20, 2016, the disclosures of which are incorporated herein by reference.

### BACKGROUND OF THE INVENTION

The invention relates to a system and method for securing a vehicle.

Battery-powered vehicles, especially electric bicycles (so-called e-bikes), are enjoying great popularity. Other electric vehicles have also gained great importance in road traffic (e.g. small electric vehicles or off-road vehicles).

Due to the high price of electric vehicles, they are exposed to a high risk of being stolen.

Traditional security mechanisms, such as number locks, which, for example, allow electric vehicles to be connected to immovable objects, have the disadvantage that they have to be carried and thus represent an increased weight. This reduces the range of the electric vehicles. In addition, it is not possible to track the electric vehicle once it has been stolen. Furthermore, carrying a lock is uncomfortable for the driver and the purchase causes additional costs.

Theft protection for motor vehicles is largely fully developed. Keyless go systems with an electronic beardless key are state of the art for motor vehicles. The beardless key can open and lock a vehicle without contact. In this case, the vehicle can be enabled for starting by radio. In addition, today's vehicles are equipped with alarm systems that trigger an alarm signal as soon as the vehicle is moved by an unauthorized person.

In the case of motor vehicles, solutions are also known in which GPS position trackers are installed in the vehicle to enable the vehicle to be tracked if it has been stolen. For this purpose, web pages are provided which visualize the position of the motor vehicle on a map.

For bicycles, Velocate has developed a system in which a GPS position tracker is arranged in the rear light of a bicycle. A warning message is sent to a user via a smartphone app as a result of shaking of the rear light, e.g. when the bicycle is moving. A Bluetooth connection is required for configuration.

The disadvantage of the solution described above is that it is necessary to continuously measure whether the bicycle is being moved. Furthermore, a corresponding sensor system is required.

Based on the prior art, it is the object of the present invention to provide a system and a method which address the disadvantages described above. In particular, it is the object of the present invention to provide a system and method that has a low energy consumption of the components used and is safe and user-friendly. Furthermore, a compact design of the individual components is to be made possible.

### BRIEF SUMMARY OF THE INVENTION

The object is solved by a system, comprising:
at least one server, in particular a cloud or web server;
at least one vehicle, in particular a bicycle, tricycle or off-road vehicle (e.g. quad, ATV, UTV), having a vehicle processing device and a vehicle communication device, wherein the vehicle communication device is designed to communicate with the server via at least one mobile network, wherein the vehicle processing device is designed to transmit data to the server.

In this case, the server has at least one allocation table which assigns at least one terminal device to the at least one vehicle, wherein the server is designed:
a) to determine whether the vehicle is being moved without authorization using the data transmitted by the vehicle;
b) to determine the associated terminal device using the allocation table in the event of unauthorized movement of the vehicle; and/or
c) to send a warning message to the corresponding terminal device in the event of unauthorized movement.

An essential core element of the invention therefore consists in the fact that only on the basis of the transmitted data of the vehicle is it determined whether the vehicle is moved without authorization. It is sufficient in one embodiment if the data indicate, for example, that the vehicle communication device communicates with a specific mobile radio cell. The mobile radio cell usually indicates a rough position. If the vehicle connects to another cell, this is an indicator that the vehicle has been moved. To determine whether the vehicle was moved without authorization, the server has at least one allocation table. The allocation table can create a unique allocation of the vehicle to terminal device. The allocation table is a very simple way of determining which terminal device is to receive a warning message. The allocation table allows vehicle-to-device relationships that include in particular 1:1, 1:N or N:M relationship types, wherein the Min-Max notation is used in this case to describe the relationship types.

Since only data has to be transferred to the server, the system can be implemented in a very energy-efficient way. In addition, the system described above allows the data to be processed at least essentially on the server. This makes it possible for the processing equipment of the vehicle to be designed as a so-called embedded processor, a processor with comparatively low performance and low power consumption. This also makes it possible to equip the vehicle with only a small amount of memory. This reduces the cost of the vehicle.

In one embodiment, the system can have at least one mobile terminal device, in particular a smartphone or a so-called wearable device.

In one embodiment, the vehicle may comprise a position determination device adapted to receive signals from a satellite navigation system and to determine a position of the vehicle. In this case, the vehicle processing device may be designed to transmit the position of the vehicle to the server. The positioning device may be, for example, a GPS or GNSS receiver. This makes it possible to determine the position of the vehicle very accurately. If the position of the vehicle is transmitted to the server, a very fast determination is possible as to whether the vehicle is moved in an unauthorized manner. This shortens the time between unauthorized movement of the vehicle and informing the corresponding terminal device.

In one embodiment, the vehicle may comprise at least one electric drive controlled by a control unit, wherein the vehicle processing device is communicatively connected to the control unit and/or the electric drive system in order to determine a driving condition. In one embodiment, the data is only sent to the server when the vehicle is moved.

In the embodiment described, the vehicle itself may therefore be designed to determine whether the vehicle is moving or not. The server can determine in the described embodiment whether the movement is carried out legitimately or not. The computing effort on the server is thus reduced.

In one embodiment, the vehicle may include a short-range communication device which may be communicatively connected to a terminal device and the vehicle processing device.

The short-range communication device may be a Bluetooth module, for example, but other technologies such as Wireless USB or 802.11A/B/G/N/AC WLAN are also possible. If the vehicle has a short-range communication device, a terminal device can communicate directly with the vehicle.

In a further embodiment, the control unit can be designed to activate the electric drive as a function of signals from the short-range communication device.

For example, the short-range communication device can receive an enable message. The enable message may indicate that the vehicle may be moved. The enable message can be received via the short-range communication device, implying that the terminal device is close to the vehicle.

It is therefore possible that a so-called keyless go functionality is provided with the described system. The terminal device assumes the role of a key. Such functionality is particularly convenient for the driver of the vehicle as he or she no longer has to carry a separate key.

The enable message can be encrypted. For example, asymmetric encryption methods using a key pair can be used. In one embodiment, therefore, the enable message encrypted via a key pair can be exchanged between the short-range communication device and a terminal device in order to activate the electric drive. In one embodiment, successful authentication of the terminal device is sufficient to activate the vehicle.

The encryption of the enable message increases the security of the system. In particular, it is therefore not possible for third parties to send an unauthorized enable message to the vehicle. Common encryption methods can be used, such as AES, SHA, PGP or other cryptographic methods that use elliptic curves on finite bodies.

In one embodiment, a key of the key pair can be component-specific and lose its validity when the component is replaced.

Components of the vehicle can be, for example, a battery, a rechargeable battery, a control unit or an electric motor. The key can then be generated at least partially on the basis of the components used. For example, the serial number or identification number of one or more components, such as a battery or rechargeable battery, could be used as a salt when generating a random key to increase the entropy of the input. Another possibility, for example, is to combine the serial numbers of different components to generate a key for the key pair. If components of the vehicle are replaced, the key loses its validity.

Alternatively, there can be an entry or a list specifying different components. In this case, it can be checked, for example, during the enable procedure, whether the existing components match those entered in the list or entry. If this is not the case, existing pairings and/or keys can be deleted or deactivated.

The advantage of the embodiment described above is that an unauthorized user cannot simply replace vehicle components without making the vehicle unfit to drive. This further increases security.

The vehicle processing device can be designed in a further embodiment
a) to switch between an active state and a passive state depending on a or the driving state and/or signals from at least one sensor, in particular an acceleration sensor, a motion sensor or a position determination device;
b) to transmit data to the server in the active state in small time intervals, for example less than 1 hour, in particular less than 10 minutes;
c) to transmit data to the server in the passive state at large time intervals, for example greater than 1 hour, in particular greater than 2 hours, or to transmit no data to the server in the passive state.

When the vehicle is moving, it is advantageous to send data to the server at a high frequency. This makes it possible to determine the position of the vehicle. If the vehicle is not moved, it is advantageous if the data is sent only rarely in order to save energy.

In one embodiment, an acceleration sensor can be used to detect whether the vehicle is in an active or passive state. The signals of the acceleration sensor can be classified for this purpose. Methods of machine learning can be considered, e.g. SVM or neural networks.

In one embodiment, the vehicle processing device may be designed to at least temporarily de-energize some components in the passive state.

For example, the vehicle processing device may be designed to de-energize the position determination device and/or the vehicle communication device. This further saves electricity when the vehicle is in a passive state.

In one embodiment, the server may store enable information for at least some vehicles, indicating whether the respective vehicle may be moved, wherein the server may be designed to determine whether the vehicle is being moved without authorization using the enable information of the respective vehicle.

In the case of the above-described embodiment, all the information is stored on the server, which enables simple management and efficient use of resources.

In one embodiment, the server can be designed for setting the respective enable information depending on instructions received from the associated terminal device.

It is therefore basically possible for the terminal device to set the enable information on the server. This enables the terminal device to control whether a movement of the vehicle is carried out in an authorized or unauthorized manner. This means that the terminal device can be used for authentication. A possibility is thus provided to efficiently implement the above mentioned keyless-go functionality.

In another embodiment, at least one terminal device may comprise an application that may be designed to communicate with the server and/or visualize information provided by the server when the application is run by the terminal device.

For example, an app can be run on the terminal device to visualize the information received. The information can, for example, be position information. Thus, the position of the vehicle can be displayed at any time, for example on a map on the terminal device. A user-friendly and clear solution is provided, which can be operated intuitively.

In one embodiment, the device can be arranged with an external service provider. An external service provider may be a private security provider or a government security agency such as the police. Furthermore, it is possible in one embodiment that the device is arranged with a fleet operator.

It is therefore possible that, in the event of unauthorized movement of the vehicle, security authorities or private service providers may be notified immediately so that they can immediately initiate the recovery of the vehicle. This increases the deterrent potential so that thefts can be prevented in advance.

The object shall also be solved by a method, in particular for a system as described above and/or for a vehicle of the system described above, comprising the steps of:
a) Transmitting data, in particular position data, by means of a vehicle communication device to a server;
b) Ascertaining whether the vehicle is being moved without authorization using the data transmitted by the vehicle;
c) Determining, using an allocation table, an associated terminal device in the event of unauthorized movement of the vehicle;
d) sending a warning message to the corresponding terminal device in case of unauthorized movement.

The advantages are similar or identical to those already described in connection with the system.

In one embodiment, the method may include a step in which a signal generator can be activated in the event of unauthorized movement. For example, a horn can be activated, so that nearby pedestrians are alerted in the event of unauthorized movement of the vehicle.

The object is further solved by a computer-readable memory with instructions for implementing the method described above when said instructions are carried out.

Furthermore, the object is solved by a system, comprising:
at least one vehicle, in particular a bicycle, tricycle or off-road vehicle (e.g. quad, ATV, UTV), comprising a vehicle processing device and a short-range communication device, wherein the vehicle comprises an electric drive controlled by a control unit, and wherein the control unit is designed to activate the electric drive as a function of signals, in particular an enable message, from the short-range communication device;
at least one terminal device, in particular a smartphone, which is designed to communicate with the vehicle via a radio link, wherein an enable message encrypted via a key pair is exchanged between the short-range communication device and the terminal device in order to activate the electric drive.

A key of the key pair is component-specific, especially based on a hardware-ID, and loses its validity when the components are replaced.

The arising advantages are similar or identical to those described above in relation to the system.

In one embodiment, the radio connection can be a Bluetooth connection.

In one embodiment, the enable message can be transmitted automatically when the distance between the terminal device and the vehicle falls below a minimum distance.

Automatic connection establishment has the advantage that the driver of the vehicle does not have to take any manual steps. This represents a very convenient solution.

In one embodiment, the vehicle may comprise a vehicle communication device which may be adapted to send data to and receive data from a mobile radio network, wherein the vehicle communication device is further adapted to receive data comprising a key, wherein the vehicle processing device may be adapted to update the key for decrypting the enable message based on the received key.

It is advantageous if the vehicle communication device can receive data comprising a key. The received data can be used to update the key. If, for example, the driver of the vehicle loses or forgets his key, the manufacturer of the vehicle can provide a new key, which may be encrypted and transmitted to the vehicle.

In one embodiment, the terminal device may comprise a biometric sensor, in particular a fingerprint scanner or an iris scanner, wherein the terminal device may be adapted to generate, using data captured by the biometric sensor, the key of the key pair with which the enable message can be encrypted.

The key to encrypt the enable message can also be created additionally based on biometric data of the driver. Thus a coupling of the key to the driver and to the vehicle is ensured.

In one embodiment, the transmission of an or the enable message may be performed automatically if it is found that the terminal device is within a reception range of the vehicle, in particular 2 meters from the vehicle, preferably 1 meter.

In one embodiment, it is possible to determine whether the terminal device is in the reception area of the vehicle on the basis of the signal strength of the radio link and/or on the basis of signal propagation times.

Furthermore, the object is solved by a vehicle, in particular a bicycle, tricycle or an off-road vehicle (e.g. quad, ATV, UTV), comprising:
a vehicle communication device;
an electric drive controlled by a control unit, wherein the control unit is designed to activate the electric drive as a function of signals, in particular an enable message, of the short-range communication device, wherein an enable message encrypted via a key pair is received by the short-range communication device in order to activate the electric drive.

In this case, a key of the key pair is component-specific, especially based on a hardware-ID, and loses its validity when the component is replaced.

Further embodiments result from the subclaims

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 shows a schematic view of an alarm system;

FIG. 2 shows a schematic view of a bicycle;

FIG. 3 shows a schematic view of a server;

FIG. 4 shows a schematic view of an allocation table;

FIG. 5 shows a flow chart of a method to warn a driver of a vehicle;

FIG. 6 shows a schematic representation of the use of a keyless-go functionality;

FIG. 7 shows a schematic representation of a vehicle battery; and

FIG. 8 shows a schematic diagram of an unlocking process.

### DETAILED DESCRIPTION OF THE INVENTION

In the following, the same reference numbers are used for identical or equivalent parts.

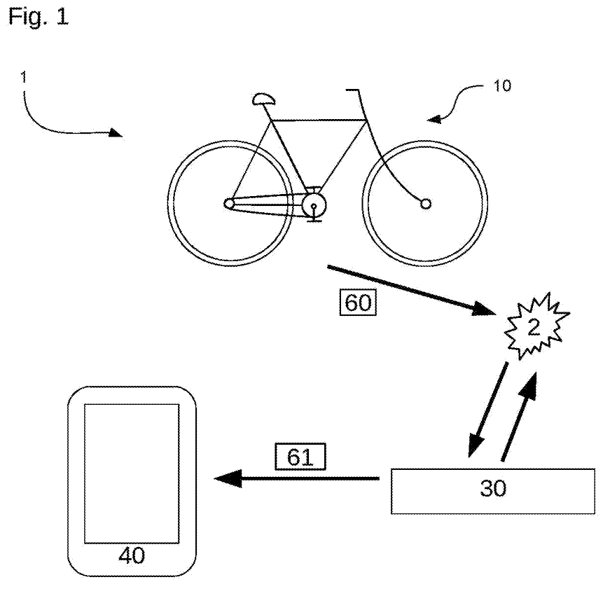

FIG. 1 shows a schematic representation of a system 1 to warn a driver. The system comprises a bicycle 10, a server 30 and a smartphone 40. For example, the smartphone 40 can be held by a driver and run an app capable of receiving warning messages 61 from a server 30. In the first embodiment example, the server 30 is designed as a web server that offers an interface that can be used by the app on the smartphone 40.

Server 30 is in communicative connection with a mobile radio network 2. Server 30 is therefore capable of receiving calls or SMS messages, for example. In addition, the server 30 is able to establish an internet connection via the mobile radio network 2. For this purpose, the server 30 can use the UMTS or LTE standard, for example. Warning message 61 could therefore also be sent via mobile radio network 2.

The bicycle 10 sends data 60 to the mobile radio network 2, which are received by the server 30. For example, data 60 could be position data 60. For example, position data 60 can be transmitted periodically, for example at intervals of 1 hour, 2 hours or even every minute.

Using the received data 60, server 30 can determine whether the bicycle 10 is moved or not. If the data 60 are GPS coordinates, server 30 can easily determine whether the GPS coordinates change. Data 60 can also be the identification number of a mobile phone cell. Server 30 can then determine whether the identification number of the mobile radio cell is changing. If there is a change in the mobile radio cell, there is a movement of the bicycle 10.

In another embodiment example, the data 60 can be used to predict the path of the bicycle 10. For example, particle filters or recurrent neural networks can be used for this purpose. In this case, historical position data can be used as evidence so that a future position can be estimated.

Server 30 can determine whether the movement is an authorized movement or an unauthorized movement after determining whether the bicycle is being moved. If the server 30 detects that the movement of the bicycle 10 is unauthorized, it sends a warning message 61 to the smartphone 40. In the first embodiment example, the warning message 61 is an SMS. In other embodiment examples, warning message 61 can also be a push message from a web service.

Warning message 61, for example, contains information on the position of the bicycle 10, so that the position of the bicycle 10 can be visualized on a map on a display device of the smartphone 40. It is also possible for the smartphone 40 to display the past movement of the bicycle 10 on a map. This means that the user of the smartphone 40 can track where the bicycle is heading at any time. Law enforcement agencies or the user per se can thus recover the bicycle 10.

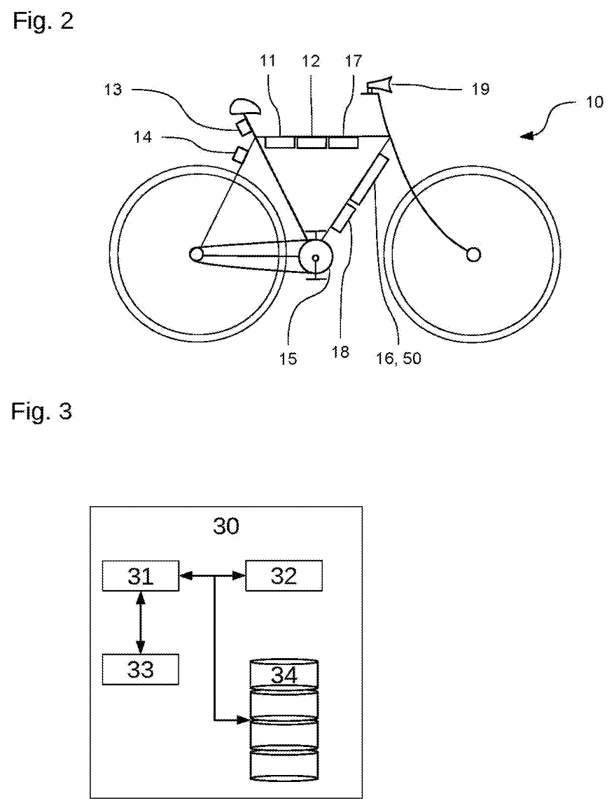

FIG. 2 shows the schematic structure of a bicycle 10 of system 1. The bicycle 10 comprises at least one vehicle processing device 11 and one vehicle communication device 12. The vehicle processing device 11 is adapted to send messages to the server 30 via a mobile radio network 2 using the vehicle communication device 12. As described above, the vehicle communication device 12 can, for example, send an SMS to server 30. The bicycle 10 shown in FIG. 2 also includes a position determination device 13. The position determination device 13 may be designed as a GPS receiver and is thus able to determine the current position of the bicycle 10.

The determined GPS coordinates can then be sent to the server 30 via the vehicle communication device 12.

However, in another embodiment example, it is also possible for the vehicle processing device 11 to check whether the position of the bicycle 10 has changed. An SMS or other message only needs to be sent to server 30 if the position of the bicycle 10 changes. This prevents messages from being sent unnecessarily.

In one embodiment example, the bicycle 10 is an electric bicycle with an electric drive 15. The electric drive 15 is powered by a battery 50 and controlled by a control unit 14. In the current embodiment example, the electric drive 15 supports the driver when pedaling. The vehicle processing device 11 can therefore also determine whether the bicycle 10 is moved when the electric drive 15 is active. In one embodiment example, the position determination device 13 can thus be dispensed with. Another possibility of determining whether the bicycle 10 is moved is to provide an acceleration sensor 17. The acceleration sensor 17 can be designed as a gyrometer, for example. The vehicle processing device 11 can determine whether there is movement of the bicycle 10 using the data generated by the acceleration sensor 17. It is therefore sufficient to provide only the acceleration sensor 17 to detect a movement of the bicycle 10.

In further embodiment examples, the vehicle communication device 12 can send the raw data or data preprocessed by the vehicle processing device 11 from the acceleration sensor 17 to the server 30.

In one embodiment example, the vehicle communication device 12 is adapted to receive messages from the server 30. For example, if the server 30 determines that a movement of the bicycle 10 is an unauthorized movement, the server 30 can send a message to the vehicle communication device 12. The vehicle processing device 11 may activate a horn 19 mounted on the bicycle 10 in response to receiving the message. This will alert passers-by to the unauthorized movement of bicycle 10.

In the embodiment example described above, the driver or owner of the bicycle 10 is informed of an unauthorized movement and can be enabled to locate the vehicle 10 using position data 60. It is also possible to activate an alarm system function on the bicycle so that passers-by are informed of theft.

FIG. 3 shows an exemplary server 30. In the example shown, the server 30 has a computing unit 31, a memory 32 and a network interface, e.g. the network card 33. In addition, the server 30 has a database with a large number of allocation tables 34.

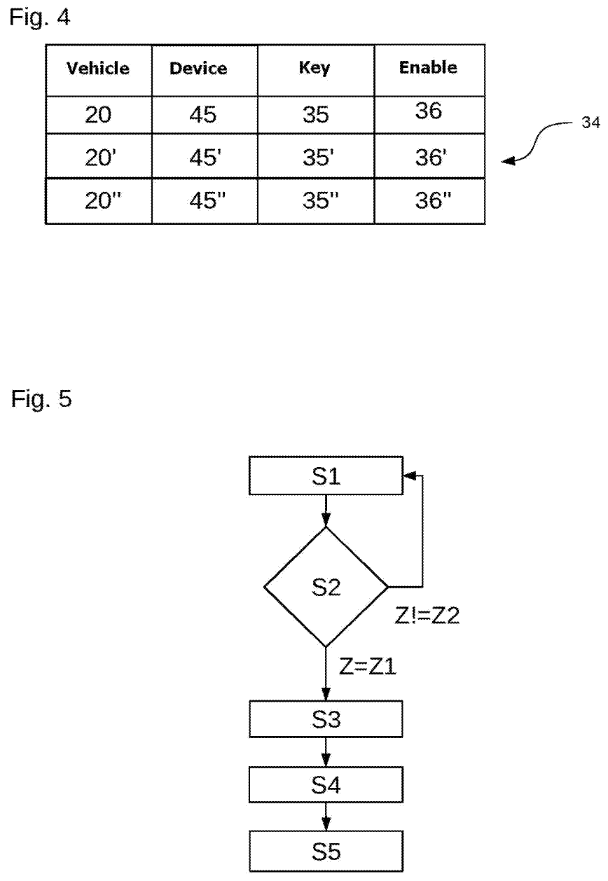

The network card 33 receives data from the bicycle 10, for example a bicycle ID together with position data 60. First the server 30 can determine whether there is a movement of the bicycle 10. In this case, past position data of the bicycle 10 stored in the memory 32 can be compared with the received position data 60. If there is a deviation in the position data, the system determines a movement. The allocation table 34 contains enable information 36, 36′, 36″ indicating whether a movement of the vehicle 10 assigned to the enable information 36, 36′, 36″ (see FIG. 4) is carried out in an authorized or unauthorized manner. Using the allocation table 34, the server 30 can therefore easily determine whether a detected movement of the bicycle 10 is being carried out with or without authorization.

If the server 30 detects that the movement of the bicycle 10 is being performed without authorization, the network card 33 sends a warning message 61 to the smartphone 40 of the driver.

FIG. 4 shows the schematic structure of an allocation table 34, which is stored in the database of the server 30. The allocation table 34 has a first column in which vehicle numbers 20, 20′, 20″ are stored. These vehicle numbers 20, 20′, 20″ may be of the type ‘Global Unique Identifier’ (GUID), which uniquely identifies a vehicle. The allocation table 34 also includes a column for device numbers 45, 45′, 45″, wherein device numbers 45, 45′, 45″ may be the IMEI numbers of terminal devices 40 such as smartphones. This means that each vehicle 10 is uniquely assigned a device 40.

From the column for vehicle numbers 20, 20′, 20″ and the column for devices 45, 45′, 45″ it can be determined to which device 40 the server 30 must send a warning message 61 if an unauthorized movement of a vehicle 10 is detected.

The allocation table may also contain a column for enable authorizations 36, 36′, 36″. The enable authorizations column indicates whether a vehicle 10 assigned to enable information 36, 36′, 36″ may be moved.

For example, if the server 30 determines that a vehicle 10 with a vehicle number 20 is being moved, the enable information 36 indicates whether this movement is being performed with or without authorization. If the movement is unauthorized, a warning message 61 is sent to device 40 with device number 45.

The allocation table 34 can also contain a column that stores keys 35, 35′, 35″ that can be used to authenticate users. For example, keys 35, 35′, 35″ may be a tuple of private and public keys of an asymmetric encryption procedure. The keys 35, 35′, 35″ can be used to verify the incoming messages 60 of the bicycle 10. This prevents unauthorized messages from being received.

In the column for devices 40, a tuple of device numbers 45, 45′, 45″ may also be indicated in other embodiment examples in addition to a single device number 45, 45′, 45″. In the column for vehicle numbers, in addition to a single vehicle number 20, a tuple of vehicle numbers 20 may also be indicated. Thus also 1:N and M:N relations can be converted with the allocation table 34. Alternatively, the allocation table 34 may include a plurality of additional columns for equipment numbers or vehicle numbers which can be used to implement the above relationship types.

In one embodiment example, a device 40 is arranged with a third party. A third party may be a private security service, the police or a fleet operator. This means that third parties can also be informed of unauthorized movements of the vehicle at any time.

FIG. 5 shows a flowchart of a method to warn a driver. In step S1, data 60 are transmitted to the server 30. The vehicle communication device 12 can be used for this purpose. Data 60 may in particular be position data of the bicycle 10.

In step S2 it is determined whether the transmitted data 60 indicate that the state Z of the vehicle 10 is a driving state Z1 or a stop state Z2. If it is determined that the state Z corresponds to a stop state Z2, the method continues with step S1. If, on the other hand, it is found that the Z state corresponds to a driving state Z1, the method continues with step S3 by determining whether the movement of the vehicle 10 is an authorized or an unauthorized movement.

The allocation table 34 is used for this purpose.

If it is determined that the movement of the vehicle 10 is an unauthorized movement, a warning message 61 shall be sent to the smartphone 40 assigned in allocation table 34.

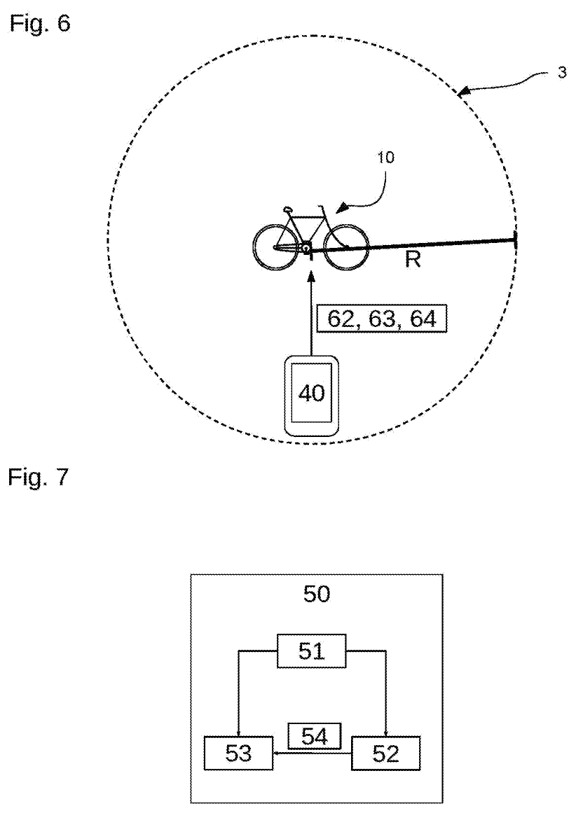

FIG. 6 shows the schematic representation of another embodiment example. In the embodiment example of FIG. 6, the bicycle 10 has an additional Bluetooth module 18 (see also FIG. 2). The smartphone 40 also has a Bluetooth module 42, allowing the smartphone 40 to communicate directly with the bicycle. In particular, the smartphone 40 can send a message 62 to the server 30 for a successfully established connection with the bicycle 10 in order to set enable information 36, 36′, 36″ in the allocation table 34 which indicates that a movement should occur in an authorized manner.

It is advantageous if the connection between smartphone 40 and bicycle 10 is automatically established as soon as the smartphone 40 is within the reception area 3 of bicycle 10.

The reception range 3 is determined by a radius R and depends on the range of the Bluetooth modules 18 and 42.

In order to establish a connection between the bicycle 10 and the smartphone 40, it is provided in the embodiment examples shown that an encrypted enable message 64 is exchanged between the bicycle 10 and the smartphone 40. This ensures that only authorized smartphones 40 communicate with the corresponding bicycles 10. The key 35, 35′, 35″ used to encrypt the message 64 can at least partly be based on the hardware components used in the bicycle 10. In this embodiment example, the key 35, 35′, 35″ is generated using the serial number of the installed rechargeable battery 50. If the rechargeable battery 50 is replaced, the key 35, 35′, 35″ loses its validity. This makes it impossible for an unauthorized user to cause an unauthorized movement of the bicycle to occur if a change is made to the bicycle.

If a connection between smartphone 40 and bicycle 10 is successfully established, the control unit 14 of the bicycle 10 can enable the electric drive 15. Normally, the electric drive 15 is switched off so that unauthorized movement of the bicycle 10 is prevented. The approach of the smartphone 40 to the bicycle 10 thus provides a so-called keyless-go functionality.

FIG. 7 shows another embodiment example of the present invention. The smartphone 40 can also be used to establish a connection with individual components 50 of the bicycle 10. In this example, a rechargeable battery 50 comprises a computing unit 51, a memory 52 and a communication device 53. The communication device 53 can read out a hardware ID 54 of the battery 50 from the memory 52 and generate a key based on this that can be used for authentication with the smartphone 40. If authentication is successful, the rechargeable battery 50 provides the power required to operate the bicycle 10.

One advantage of the illustrated embodiment is that, for example, bicycles 10 or vehicles 10 can also be retrofitted with keyless go functionality.

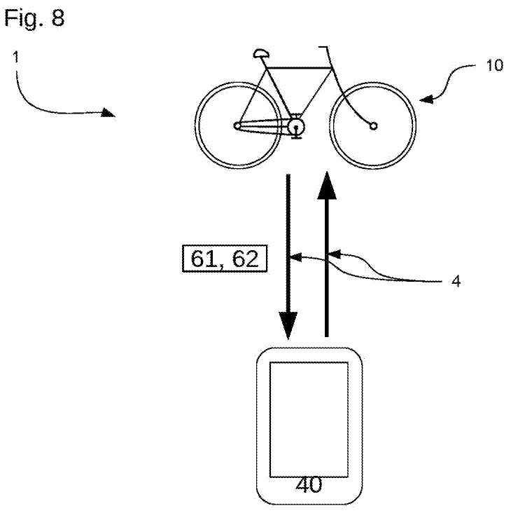

FIG. 8 shows an embodiment example in which the server 30 can be omitted. In this case, communication between smartphone 40 and bicycle 10 takes place via a radio link 4, and a warning message 61 is sent directly from the bicycle 10 to the smartphone 40.

It is clear to the person skilled in the art that the embodiment examples and embodiments described above are merely exemplary and that the individual aspects of the embodiment examples can be combined with each other without deviating from the inventive idea.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-17. (canceled)

18. A system comprising:
at least one server in particular a cloud or web server;
at least one vehicle, in particular a bicycle, tricycle or off-road vehicle (e.g. quad, ATV, UTV), having a vehicle processing device and a vehicle communication device, wherein the vehicle communication device is designed to communicate with the server via at least one mobile network, and wherein the vehicle processing device is designed to transmit data to the server, and
wherein the server has at least one allocation table which assigns at least one terminal device to the at least one vehicle, and wherein the server is designed for:
a) determining, by using the transmitted data of the vehicle, whether the vehicle is being moved without authorization;
b) determining, in the event of unauthorized movement of the vehicle, the associated terminal device by using the allocation table; and/or
c) sending a warning message to the associated terminal device in the event of unauthorized movement.

19. The system according to claim 18, wherein the at least one vehicle comprises a position determination device, such as a GPS or GNSS receiver, for receiving signals from a satellite navigation system and for determining a position of the vehicle, wherein the vehicle processing device is designed to transmit the position of the vehicle to the server.

20. The system according to claim 18, wherein the at least one vehicle comprises at least one electric drive controlled via a control unit, wherein the vehicle processing device is communicatively connected to the control unit and/or the at least one electric drive to determine a driving state indicating that the vehicle is being moved.

21. The system according to claim 20, wherein the at least one vehicle comprises a short-range communication device, such as a Bluetooth module, which is communicatively connected to a mobile terminal device and the vehicle processing device.

22. The system according to claim 21, wherein the control unit is designed to activate the at least one electric drive as a function of signals, in particular an enable message, of the short-range communication device.

23. The system according to claim 22, wherein for activation of the at least one electric drive, the enable message encrypted via a key pair is exchanged between the short-range communication device and the mobile terminal device.

24. The system according to claim 23, wherein a key of the key pair is component-specific and loses its validity with an exchange of a battery or a rechargeable battery.

25. The system according to claim 18, wherein the vehicle processing device is designed:
a) to change between an active state and a passive state as a function of a driving state (Z, Z1) and/or signals from at least one acceleration sensor;
b) to transmit data to the server in the active state at small time intervals, for example less than 1 hour, in particular less than 10 minutes; and
c) to transmit data to the server in the passive state at large time intervals, for example greater than 1 hour, in particular greater than 2 hours, or to transmit no data to the server in the passive state.

26. The system according to claim 25, wherein the vehicle processing device is designed, in the passive state, to at least temporarily de-energize some components, for example a position determination device and/or the vehicle communication device.

27. The system according to claim 18, wherein the server stores enable information for at least some of the vehicles indicating whether the respective vehicle may be moved, wherein the server is adapted to determine, by using the enable information-of the respective vehicle, whether the respective vehicle is being moved in an unauthorized way.

28. The system according to claim 27, wherein the server is designed for setting the respective enable information depending on instructions which are received from the associated mobile terminal device.

29. The system according to claim 18, wherein at least one mobile terminal device comprises an application which is designed to communicate with the server-and/or to visualize information provided by the server, in particular position information, when the application is run by the mobile terminal device.

30. A method for operating the system according to claim 18, the method comprising steps of:
a) transmitting data, in particular position data, by a vehicle communication device to a server;
b) ascertaining, by using the transmitted data of the vehicle, whether the vehicle is being moved without authorization;
c) determining, by using an allocation table of an associated terminal device, in case of unauthorized movement of the vehicle; and
d) sending a warning message to the associated terminal device in the event of unauthorized movement.

31. The method according to claim 30, further comprising a step of:
e) activating a signal generator, for example a horn, in an event of unauthorized movement.

32. A computer-readable memory containing instructions for implementing the method according to claim 30 when they are carried out.

33. A system, comprising:
at least one vehicle, in particular a bicycle, tricycle or off-road vehicle (e.g. quad, ATV, UTV), comprising a vehicle processing device and a short-range communication device, wherein the vehicle comprises an electric drive controlled by a control unit, and wherein the control unit is designed to activate the electric drive as a function of signals, in particular an enable message, of the short-range communication device;
at least one mobile terminal device, in particular a smartphone, which is designed to communicate with the vehicle via a radio link, wherein
an enable message encrypted via a key pair is exchanged between the short-range communication device and the mobile terminal device to activate the electric drive, wherein a key of the key pair is component-specific, in particular based on a hardware ID, and loses its validity with an exchange of the component.

34. A vehicle comprising:
a vehicle communication device; and
an electric drive controlled by a control unit, wherein the control unit is designed to activate the electric drive as a function of signals, in particular an enable message, of the short-range communication device, and wherein an/the enable message-encrypted via a key pair is received by the short-range communication device in order to activate the electric drive,
wherein a key of the key pair is component-specific, in particular based on a hardware ID, and loses its validity with an exchange of the component.
